(19) United States
(12) Patent Application Publication
(10) Pub. No.: US 2007/0238830 A1
(43) Pub. Date: Oct. 11, 2007

(54) Aqueous polyurethane dispersions with improved storage stability

(75) Inventors: Rolf Gertzmann, Leverkusen (DE); Christoph Irle, Sant Just Desvern (ES); Rolf Roschu, Willich (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/784,643

(22) Filed: Apr. 9, 2007

(30) Foreign Application Priority Data
Apr. 11, 2006 (DE) 102006017385.6

(51) Int. Cl. C08G 18/08

(52) U.S. Cl. 524/589

(57) ABSTRACT

The invention relates to aqueous polyurethane dispersions with a high hard-segment fraction and improved storage stability, to a process for preparing them, and to coating compositions prepared from them.

### CROSS-REFERENCE TO RELATED APPLICATIONS

The present application claims the right of priority under 35 U.S.C. §119 (a)-(d) of German Patent Application Number 10 200 017 385.6, filed Apr. 11, 2006.

### BACKGROUND OF THE INVENTION

The invention relates to aqueous polyurethane dispersions with a high hard-segment fraction and improved storage stability, to a process for preparing them, and to coating compositions prepared from them.

With the objective of lowering the emissions of organic solvents, aqueous coating compositions are increasingly being used in place of solvent-borne systems. An important class of aqueous film-forming binders are polyurethane dispersions. Solvent-free polyurethane dispersions (called PUD below) are obtainable both by the acetone method and by the prepolymer mixing method.

In many polyurethanes, N-methylpyrrolidone (NMP) is used as a solvent, since it is inert towards isocyanate groups and is therefore suitable for reducing the viscosity during prepolymer construction. NMP, furthermore, is capable of dissolving the high-melting dimethylolpropionic acid which is much used in PUD chemistry. The use of NMP ensures that there is a sufficient number of hydrophilic centers, in the form of carboxylate groups incorporated into the polyurethane skeleton within an economically acceptable reaction time. However, NMP is to be classified as an embryotoxic substance, and therefore, a substitute is needed for this solvent.

Attempts to replace NMP quantitatively with solvents such as acetone or methyl ethyl ketone, which can be removed by distillation, in the preparation of ionically hydrophilicized polyurethane dispersions having diol contents, based on diols having average molar weights Mₙ of 62 g/mol to 500 g/mol, of greater than 5% by weight and hard-segment contents of 55% to 85% by weight, have led to products with inadequate storage stability when foregoing the use of the carcinogenic hydrazine in the chain extension step. Hydrazine is widely used in the synthesis both of NMP-containing and of solvent-free polyurethane dispersions in order to realize an improved yellowing resistance on the part of the coatings obtained from the dispersions. A stabilization of the dispersion particles, particularly of dispersion particles comprising very hard polyurethanes, by hydrazine has not hitherto been observed.

EP-A 801 086 claims FDA-compliant polyurethane dispersions which contain no free amines. This was achieved by chain-extending isocyanate-functional (NCO) prepolymers with monoamines and polyamines. The NCO prepolymers needed for the preparation of the dispersion contain 0.1% to 5.0% by weight of diols having OH numbers between 111 and 1250, and following chain extension have only low levels of hardness, which fail to satisfy the requirements in many sectors, such as in the coating of floor coverings, for example.

DE 19930961 A1 describes polyurethane dispersions containing N-methylpyrrolidone and possibly also hydrazine hydrate. N-methylpyrrolidone can only be removed from these dispersions very laboriously. DE 102005019397 A1 is prior art according to § 3(2) No. 1 of the Patents Act. The polyurethane dispersions with improved film forming properties described in DE 102005019397 A1 contain hydrazine hydrate.

The object of the present invention is to provide ionically hydrophilicized polyurethane dispersions which are solvent-free and NMP-free, are prepared without hydrazine and have a storage stability of at least six weeks at 40° C. The coating compositions based on the polyurethane dispersions according to the invention, and the coatings produced from them, also have good resistances to chemicals and water and also pendulum hardnesses of more than 90 seconds.

Surprisingly it has been possible to achieve this object by using components which are monofunctional with respect to isocyanates, such as monoalcohols having average molar weights Mₙ of 32 g/mol to 145 g/mol and/or monoamines g) having average molar weights Mₙ of less than 147 g/mol.

### SUMMARY OF THE INVENTION

The present invention accordingly provides hydrazine-free aqueous polyurethane dispersions (I) comprising
a) one or more polyisocyanates,
b) one or more polyols having average molar weights Mₙ of 500 g/mol to 6000 g/mol,
c) one or more polyols having average molar weights Mₙ of 62 g/mol to 500 g/mol,
d) one or more compounds containing an ionic group or a group capable of forming an ionic group,
e) one or more polyamines having average molecular weights Mₙ below 500 g/mol,
f) optionally one or more monoalcohols having average molar weights Mₙ of 32 g/mol to 145 g/mol and
g) optionally one or more monoamines having average molar weights Mₙ of less than 147 g/mol,
   wherein at least one of f) and g) are used, the fraction of f) and/or g) being 0.4% to 1.6% by weight, the fraction of component c) being greater than 5.5% to 22% by weight, and the hard-segment fraction of the polyurethane dispersion being between 55% to 85% by weight, measured on the basis of the resin of the polyurethane dispersion (I).

### DETAILED DESCRIPTION OF THE PREFERRED EMBODIMENTS

Preferably the resin of the inventive polyurethane dispersion (I) has a component c) content of 5% to 22%, preferably of 7% to 20% and with particular preference of 9% to 17% by weight, a hard-segment (HS) content of 55% to 85%, preferably of 58% to 80% and with particular preference of 60% to 75% by weight, the amount of isocyanate, based on the amount of solids, being 35% to 55%, preferably 38% and 50%, with particular preference 40% to 48% by weight. The acid number of the solid resin is between 11 and 30 mg KOH/g solid resin, preferably between 13 and 28 mg KOH/g solid resin and with particular preference between 15 and 27 mg KOH/g solid resin.

The hard-segment content is calculated as follows:

$$HS = \frac{100 * [ Σ mass ( a , c , d , e , f , g ) ]}{Σ mass ( a , b , c , e , f , g )}$$

The inventive polyurethane dispersion contains not more than 0.9% by weight, preferably not more than 0.5% by weight, of organic solvents. The inventive polyurethane dispersion is free, moreover, from N-methylpyrrolidone (NMP).

Component a) suitably includes the polyisocyanates typically used in polyurethane chemistry, such as diisocyanates of the formula R¹(NCO)₂, R¹ being an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Examples of preferred diisocyanates are tetramethylene diiso-cyanate, hexamethylene diisocyanate, 4,4′-diisocyanatodiphenylmethane, 2,4′-diisocyanatodiphenylmethane, 2,4-diisocyanatotoluene, 2,6-diisocyanato-toluene or α,α,α′,α′,-tetra-methyl-m- or p-xylylene diisocyanate and also mixtures of the stated diisocyanates. Particularly preferred diisocyanates are 1-isocyanato-3,3,5-trimethyl-5-isocyanatomethylcyclohexane (isophorone diisocyanate) and 4,4′-diisocyanatodicyclohexylmethane.

Where appropriate it is possible to use small amounts of isocyanates with a functionality of three and/or more, for example, in order thereby to ensure a certain degree of branching or of crosslinking in the polyurethane. The amount of polyisocyanate to be used is governed by its functionality and should be calculated such that the NCO prepolymer still remains stirrable and dispersible. Such isocyanates are obtained, for example, by reacting difunctional isocyanates with one another in such a way that some of their isocyanate groups are derivatized to form isocyanurate, biuret, allophanate, uretdione or carbodiimide groups. Those polyisocyanates hydrophilicized by way of ionic groups, of the kind typically used as crosslinkers in aqueous two-component (2K) PU coating materials, are also suitable. Examples of such isocyanates are described in EP-A 510 438, in which polyisocyanates are reacted with OH-functional carboxyl compounds. Hydrophilicized polyisocyanates are obtained, moreover, by reacting polyisocyanates with isocyanate-reactive compounds which carry sulphuric acid groups. Polyisocyanates of this kind may have high functionalities, of more than 3, for example.

Suitable polymeric polyols b) have a molar weight range (Mₙ) of 500 to 6000 g/mol, preferably of 500 to 3000 g/mol and with particular preference of 650 to 2500 g/mol. The OH functionality is at least 1.8 to 3, preferably 1.9 to 2.2 and with particular preference 1.92 to 2.0. The polyols are, for example, polyesters, polyethers based on propylene oxide and/or tetrahydrofuran, polycarbonates, polyestercarbonates, polyacetals, polyolefins, polyacrylates and polysiloxanes. Preference is given to using polyesters, polyethers, polyestercarbonates and polycarbonates. Particular preference is given to polyesters, polyethers, polyestercarbonates and polycarbonates having OH functionalities between 1.92 and 2.0. Mixtures of the polymeric polyols b) described are likewise suitable.

In addition, in a blend with the stated polyols b), it is also possible to use fatty acid-containing polyesters b1), which are obtained by esterification or transesterification product(s) of drying and/or non-drying fatty acids and/or oils with at least bifunctional polyol compounds, as are described in EP-A 0 017 199, for example (p. 10, line 27 to p. 11, line 31). Polyol compounds used are preferably tetrafunctional hydroxyl components such as pentaerythritol, for example.

Likewise suitable as polyol b1) is partially dehydrated castor oil, which is obtained by subjecting castor oil to thermal exposure under acid catalysis, and is described in EP-A 0 709 414 (p. 2, lines 37-40).

Likewise suitable as polyols b1) are those which are disclosed in DE-A 199 30 961 (p. 2, lines 46-54; p. 2, line 67 to p. 3, line 3). In that reference, aliphatic and cycloaliphatic monocarboxylic acids having 8 to 30 carbon atoms such as oleic acid, lauric acid, linoleic acid or linolenic acid, for example, are reacted with castor oil in the presence of glycerol.

Additionally suitable as polyols b1) are transesterification products of castor oil with a different or with two or more different triglycerides. In that case the molar composition of the mixture is calculated such that the average OH functionality of the end product is 2.

Particular preference is given as component b1) to fatty acid-containing components which are on average bifunctional with respect to the OH groups and contain glycerol or trimethylolpropane units. Very particularly preferred in this context are transesterification products having average OH functionalities of 2 of castor oil with a further oil, different from castor oil. The fatty acid-containing polyesters b1) are preferably used with polyols b) having an Mₙ of 650 to 2500 g/mol and OH functionalities of 1.9 to 2. With particular preference the fatty acid-containing polyesters b1) are employed with polyols b) which have an Mₙ of 650 to 2500 g/mol, which have OH functionalities of 1.92 to 2 and which are selected from the group of esters, ethers, carbonates or carbonate esters.

With preference the inventive polyurethane dispersion (I) contains only component b) in amounts of 15% to 45%, preferably of 20% to 42% and with particular preference of 25% to 40% by weight based on (I).

In a further embodiment of the present invention the inventive polyurethane dispersion (I) comprises components b) and b1), the total amount thereof being not more than 45% by weight, measured on the basis of the total amount of resin from components a) to g), and the amount of component b1), based on the total resin amount of the polyurethane dispersion (I), is 10% to 30%, preferably 15% to 25% by weight. The amount of component b) in that case, based on the total resin amount of the polyurethane dispersion (I), is 15% to 35%, preferably 20% to 30% by weight.

Low molecular weight polyols c) with a molecular weight range (Mₙ) of 62 to 500 g/mol, preferably 62 to 400 g/mol and with particular preference 90 to 300 g/mol are the bifunctional alcohols which are typically used in polyurethane chemistry, such as ethanediol, 1,2- and 1,3-propanediol, 1,2-, 1,3- and 1,4-butanediol, 1,5-pentanediol, 3-methylpentane-1,5-diol, 1,6-hexanediol, neopentyl glycol, cyclohexane-1,4-dimethanol, 1,2- and 1,4-cyclohexanediol, 2-ethyl-3-propylpentanediol, 2,4-dimethylpentanediol, 2-ethyl-2-butylpropanediol, diols containing ether oxygen, such as diethylene glycol, triethylene glycol, tetraethylene glycol, dipropylene glycol, tripropylene glycol, polyethylene glycols, polypropylene glycols or polybutylene glycols, N-substituted ethanolamines, and mixtures of these products. Preferred polyols c) are 1,4-butanediol, 1,5-pentanediol, 3-methylpentane-1,5-diol, 1,6-hexanediol, neopentyl glycol, cyclohexane-1,4-dimethanol, 1,2- and 1,4-cyclohexanediol, and N-substituted ethanolamines. Especially preferred polyols c) are 1,4-butanediol, 1,6-hexanediol, neopentyl glycol, and N-substituted ethanolamines.

Alcohols of the stated molecular weight range with a functionality of three or more can be used as well in proportion in an amount such that the polymer solution remains stirrable. Components of this kind include trimethylolpropane, glycerol, and pentaerythritol.

In addition, in a blend with the stated polyols c), it is also possible to use fatty acid-containing polyesters c1) having molar weights <500 g/mol, which are obtained by esterification or transesterification product(s) of drying and/or non-drying fatty acids and/or oils with at least bifunctional polyol compounds, as described for example in EP-A 0 017 199 (p. 10, line 27 to p. 11, line 31). Polyol compounds used are preferably trifunctional and tetrafunctional hydroxyl components such as trimethylolethane, trimethylolpropane, glycerol or pentaerythritol, for example.

The amounts of components c) and c1) are calculated such that their total, measured in relation to the resin of the polyurethane dispersion (I), is 5% to 22%, preferably 7% to 20% and with particular preference 9% to 17% by weight. The ratio of c) to c1) ranges from 100:0 to 20:80, preferably from 100:0 to 30:70 and with particular preference from 100:0 to 40:60.

In one preferred embodiment only component c) is used in amounts of 5% to 22%, preferably 7% to 20% and with particular preference 9% to 17% by weight, measured on the basis of the resin of the polyurethane dispersion (I).

Suitable components d) are low molecular weight compounds which contain ionic groups or are capable of forming an ionic group, such as dimethylolpropionic acid, dimethylolbutyric acid, hydroxypivalic acid, reaction products of (meth)acrylic acid and polyamines (e.g. DE-A-19 750 186, p. 2, lines. 52-57) or polyol components containing sulphonate groups, such as the propoxylated adduct of sodium hydrogen sulphite with 2-butanediol, for example, or the polyesters described in EP-A 0 364 331 (p. 6, lines. 1-6) and constructed from salts of sulphoisophthalic acid.

Carboxylic acid group-containing components are preferred. Particular preference is given to dimethylolpropionic acid.

Suitable neutralizing components for the anionic dispersions are the known tertiary amines, ammonia and alkali metal hydroxides.

The NCO prepolymer preferably contains no nonionic hydrophilicizing agents.

Suitable chain extenders e) include polyamines having a molar weight Mₙ below 500 g/mol, such as ethylenediamine, 1,2-diaminopropane, 1,4-diaminobutane, 1,6-hexamethylenediamine, 2-methylpentane-1,5-diamine, isophoronediamine, 4,4′-diaminodicyclohexylmethane, piperazine, N²-methyldiethylenetriamine or diethylenetriamine. The diamines ethylenediamine, 2-methylpentane-1,5-diamine or isophoronediamine are preferred.

Suitable components f) include monofunctional alcohols having 1 to 18, preferably 1 to 12, with particular preference 1-8 carbon atoms. These include, for example, methanol, ethanol, 1-propanol, 2-propanol, primary butanol, secondary butanol, n-hexanol and its isomers, 2-ethylhexyl alcohol, ethylene glycol monomethyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, 1-octanol, 1-dodecanol, 1-hexadecanol, lauryl alcohol and stearyl alcohol. Regarded as preferred components f) are ethanol, 1-propanol, 2-propanol, primary butanol, secondary butanol, n-hexanol and its isomers, 2-ethylhexyl alcohol, ethylene glycol monomethyl ether, diethylene glycol monomethyl ether, ethylene glycol monobutyl ether and diethylene glycol monobutyl ether. Regarded as particularly preferred components f) are n-butanol, n-hexanol, 2-ethylhexyl alcohol, ethylene glycol monobutyl ether or ethylene glycol monomethyl ether.

Suitable monoamines g) are those which have a molar weight below 147 g/mol, such as ammonia, methylamine, ethylamine, diethylamine, propylamine, n-butylamine, dibutylamine, 2-aminobutane, 1-aminopentane, 2-aminopentane, ethanolamine, diethanolamine, 1-amino-2-propanol, 3-amino-1-propanol, 2-amino-1-butanol, 5-amino-1-pentanol. The preferred monoamines g) include n-butylamine, 2-aminobutane, 1-aminopentane, 2-aminopentane, ethanolamine or diethanolamine. Especially preferred components g) are n-butylamine or diethanolamine.

Suitable solvents for preparing the polyurethane dispersion (I) include those which boil below 100° C. under atmospheric pressure, contain no isocyanate-reactive groups, and are also water-soluble. Furthermore, the solvent must be able to be removed by distillation from the dispersion prepared. Examples of such solvents are acetone, methyl ethyl ketone, tert-butyl methyl ether or tetrahydrofuran. Preference is given to using methyl ethyl ketone or acetone as solvent, particular preference being given to acetone.

The amount of solvent is chosen such that the prepolymer prior to the dispersing step occupies a fraction in terms of weight of between 66% and 98%.

Likewise provided for the present invention is a process for preparing the inventive aqueous polyurethane dispersions, characterized in that
I) a polyurethane dispersion is prepared without addition of hydrazine, where
I.1) first of all in a first step an NCO prepolymer solution in a concentration of 66% to 98% in a solvent having a boiling point below 100° C. under atmospheric pressure is obtained by reacting components a), b), c) and d),
I.2) in a second step the NCO prepolymer I.1) is dispersed in water, with at least partial neutralization of the ionic groups taking place before, during or after dispersion,
I.3) in a third step a chain extension takes place with component e), and
I.4) in a fourth step the solvent is removed by distillation,
   with the proviso that component f) is used in step I.1) and/or component g) in step I.3), preferably component f) is used in step I.1) and component g) in step I.3) and with particular preference only component f) is used in step I.1).

In step I.1) of the process for preparing the inventive polyurethane dispersions, the NCO prepolymer ought to have an NCO functionality of <2.3. The solvent can be added before, during or after the prepolymerization in an amount such as to form a 66% to 98% strength solution, preferably a 75% to 95% strength solution. A neutralizing agent needed for neutralizing the potentially ionic groups may already be present at the beginning of the reaction, but, unless it is added to the dispersing water, must be added no later than to the ready-prepared prepolymer. Alternatively the amount of neutralizing amine can be divided up between organic phase and aqueous phase prior to dispersing.

In step I.2) of the process, the dispersing operation takes place, and involves either adding the water to the resin or, conversely, adding the resin to the water under sufficient shearing conditions.

In the third step I.3), the chain extension is carried out, the amount of the nitrogen-containing, isocyanate-reactive component(s) e) and g) in the form of an aqueous solution being calculated such that 25% to 105%, preferably 50% to 100%, with particular preference 55% to 90% of the isocyanate groups can be theoretically consumed by reaction. The amines e) and g) can also be added to the dispersion as a solution in the solvent used to prepare the prepolymer. Any isocyanate groups that remain react with the water present, thereby extending the chain. The complete distillative removal of the solvent is accomplished preferably under vacuum and forms the fourth step I.4).

The solids content of the solvent-free dispersion lies between 25% to 65% by weight. A solids content of 30% to 50% by weight is preferred, one of 34% to 45% by weight particularly preferred.

Likewise provided for the present invention are coating compositions comprising the inventive polyurethane dispersions.

The resulting coating compositions comprising the inventive polyurethane dispersions can be applied as a physically drying one-component (1K) system or else as a two-component (2K) system.

The present invention accordingly also provides for the use of the inventive polyurethane dispersions as binders in 1K systems or as a binder constituent in a 2K system.

In the case of the 2K systems the inventive dispersions are cured preferably with the hydrophilic and/or hydrophobic paint polyisocyanates that are known to the skilled person. When using the paint polyisocyanates it may be necessary to dilute them with further quantities of cosolvent in order to achieve effective mixing of the polyisocyanates with the dispersion. Suitable solvents here are solvents which are inert towards isocyanate groups, such as ethyl glycol dimethyl ether, triethyl glycol dimethyl ether, diethyl glycol dimethyl ether, Proglyde® DMM (dipropylene glycol dimethyl ether), butyl acetate or methoxybutyl acetate, for example.

After being formulated with coalescers, the coating compositions of the invention can be applied to any desired substrates, examples being wood, metal, plastic, paper, leather, textiles, felt, glass or mineral substrates, and also to already coated substrates. One particularly preferred application is the use of the inventive polyurethane dispersions as aqueous coating compositions for producing coatings on wood, plastics or open-pored mineral substrates.

The present invention also provides substrates with one or more coatings, characterized in that at least one coating has been produced by applying a coating composition comprising the inventive polyurethane dispersions.

Examples of suitable coalescers include OH-monofunctional ethylene-glycolic or propylene-glycolic ethers or a mixture of such ethers. Examples of such OH-monofunctional ethylene-glycolic or propylene-glycolic ethers are ethyl glycol methyl ether, ethyl glycol ethyl ether, diethyl glycol ethyl ether, diethyl glycol methyl ether, triethyl glycol methyl ether, butyl glycol, butyl diglycol, propylene glycol monomethyl ether, dipropylene glycol monomethyl ether, propylene glycol monobutyl ether, propylene glycol monopropyl ether, dipropylene glycol monopropyl ether or propylene glycol butyl ether. Further suitable coalescing auxiliaries include ethyl glycol dimethyl ether, triethyl glycol dimethyl ether, diethyl glycol dimethyl ether and Proglyde® DMM (dipropylene glycol dimethyl ether). Preference is given to ethyl glycol methyl ether, butyl glycol, butyl diglycol, propylene glycol monomethyl ether and propylene glycol monobutyl ether.

The inventive coating compositions can be used as they are or in combination with further auxiliaries and adjuvants known from coating technology, such as fillers and pigments, for example.

The coating compositions comprising the inventive polyurethane dispersion can be applied in a known way, such as by spreading, pouring, knifecoating, injecting, spraying, spincoating, rolling or dipping, for example.

### EXAMPLES

TABLE 1
Components employed

| Trade name | Identification | Manufacturer |
|---|---|---|
| Desmodur ® W | 4,4′-Diisocyanatodicyclo- | Bayer MaterialScience AG, |
| | hexylmethane | Leverkusen, Germany |
| Desmodur ® I | Isophorone diisocyanate | Bayer MaterialScience AG, |
| | | Leverkusen, Germany |
| Desmophen ® C 1200 | Polycarbonate ester, F = 2, OHN ≈ 56 mg | Bayer MaterialScience AG, |
| | KOH/g | Leverkusen, Germany |
| Arcol ® PPG 1000 | Polypropylene glycol, F = 2, OHN ≈ 112 mg | Bayer MaterialScience AG, |
| | KOH/g | Leverkusen, Germany |
| Rewomid ® DC 212 S | Coconut oil fatty acid | Tego Chemie, Essen, |
| | diethanolamide, F ≈ 2, OHN ≈ 292 | Germany |

### Dispersion 1 (Inventive)

205.5 g of a polyester (adipic acid, 1,6-hexanediol; OH number 66 mg KOH/g), 19 g of dimethylolpropionic acid and 58.0 g of 1,6-hexanediol were dewatered under vacuum at 110° C. The mixture was then cooled to 55° C., admixed in succession with 124.2 g of acetone and 226.9 g of Desmodur® I, and boiled under reflux until an NCO content of 3.9% by weight (theoretical NCO content 4.0%) was reached. The temperature was again adjusted to 55° C. and the clear solution was admixed with 12.9 g of triethylamine, which was stirred in thoroughly. The total neutralized prepolymer solution (55° C.) was dispersed with vigorous stirring in 646 g of water which was at a temperature of 30° C. Dispersion was followed by 5 minutes of stirring, before a solution of 8.0 g of ethylenediamine and 5.2 g of 26% strength aqueous NH₃ solution, dissolved in 72.0 g of water, was added over the course of 5 minutes. Thereafter the acetone was removed by distillation at 40° C. under vacuum (120 mbar). For the reaction of the remaining isocyanate groups the batch was stirred at 40° C. until NCO groups were no longer detectable by IR spectroscopy. After the dispersion had been cooled to 30° C. it was filtered through a 240 μm rapid filter.

Characteristics of the polyurethane dispersion:

| | |
|---|---|
| Average particle size: | 65 nm |
| pH (20° C.) (10% strength aqueous solution): | 7.8 |
| Hard-segment content: | 60% |
| Acid number (based on solid resin): | 15.5 mg KOH/g |

### Dispersion 2 (Inventive)

205.5 g of a polyester (adipic acid, 1,6-hexanediol; OH number 66 mg KOH/g), 19 g of dimethylolpropionic acid and 58.0 g of 1,6-hexanediol were dewatered under vacuum at 110° C. The mixture was then cooled to 55° C., admixed in succession with 124.2 g of acetone and 226.9 g of Desmodur® I, and boiled under reflux until an NCO content of 3.9% by weight (theoretical NCO content 4.0%) was reached. The temperature was again adjusted to 55° C. and the clear solution was admixed with 12.9 g of triethylamine, which was stirred in thoroughly. The total neutralized prepolymer solution (55° C.) was dispersed with vigorous stirring in 646 g of water which was at a temperature of 30° C. Dispersion was followed by 5 minutes of stirring, before a solution of 8.0 g of ethylenediamine and 5.8 g of butylamine, dissolved in 72.0 g of water, was added over the course of 5 minutes. Thereafter the acetone was removed by distillation at 40° C. under vacuum (120 mbar). For the reaction of the remaining isocyanate groups the batch was stirred at 40° C. until NCO was no longer detectable by IR spectroscopy. After the dispersion had been cooled to 30° C. it was filtered through a 240 μm rapid filter.

Characteristics of the polyurethane dispersion:

| | |
|---|---|
| Average particle size: | 55 nm |
| pH (20° C.) (10% strength aqueous solution): | 8.0 |
| Hard-segment content: | 60% |
| Acid number (based on solid resin): | 15.5 mg KOH/g |

### Dispersion 3 (Inventive)

A mixture of 340.8 g of Desmophen® C 1200, 33.0 g of dimethylolpropionic acid, 62.0 g of neopentyl glycol, 1.9 g of ethylene glycol monobutyl ether and 18.2 g of Rewomid® DC 212 S in 241.1 g of acetone was heated to 70° C. and 407.0 g of Desmodur® W were added. Then 24.8 g of triethylamine were added and the mixture was stirred at 70° C. until the NCO content was 3.4%. 900 g of this solution were dispersed with vigorous stirring in 977 g of water, which was introduced at a temperature of 30° C. Stirring was continued for 5 minutes after dispersion, before, over the course of 5 minutes, a solution of 8.0 g of diethylene-triamine and 11.2 g of ethylenediamine in 100 g of water was added. After a further 10 minutes the acetone was removed by distillation under vacuum. After the dispersion had been cooled to 30° C. it was filtered through a 240 μm rapid filter.

Characteristics of the polyurethane dispersion:

| | |
|---|---|
| Average particle size (LCS): | 49 nm |
| pH (20° C.): | 8.2 |
| Solids content: | 35% |
| Acid number (based on solid resin): | 16.0 mg KOH/g |

### Comparative Dispersion 4

205.5 g of a polyester (adipic acid, 1,6-hexanediol; OH number 66 mg KOH/g), 19 g of dimethylolpropionic acid and 58.0 g of 1,6-hexanediol were dewatered under vacuum at 110° C. The mixture was then cooled to 55° C., admixed in succession with 124.2 g of acetone and 226.9 g of Desmodur® I, and boiled under reflux until an NCO content of 3.9% by weight (theoretical NCO content 4.0%) was reached. The temperature was again adjusted to 55° C. and the clear solution was admixed with 12.9 g of triethylamine, which was stirred in thoroughly. The total neutralized prepolymer solution (55° C.) was dispersed with vigorous stirring in 646 g of water which was at a temperature of 30° C. Dispersion was followed by 5 minutes of stirring, before a solution of 10.3 g of ethylenediamine dissolved in 90 g of water, was added over the course of 5 minutes. Thereafter the acetone was removed by distillation at 40° C. under vacuum (120 mbar). For the reaction of the remaining isocyanate groups the batch was stirred at 40° C. until NCO was no longer detectable by IR spectroscopy. After the dispersion had been cooled to 30° C. it was filtered through a 240 μm rapid filter.

| Average particle size: | 65 nm |
|---|---|
| pH (20° C.) (10% strength aqueous solution): | 7.8 |
| Hard-segment content: | 60% |

### Comparative Dispersion 5

A mixture of 340.8 g of Desmophen® C 1200, 33.0 g of dimethylolpropionic acid, 62.9 g of neopentyl glycol and 18.2 g of Rewomid® DC 212 S in 241.1 g of acetone was heated to 70° C. and 407.0 g of Desmodur® W were added. Then 24.8 g of triethylamine were added and the mixture was stirred at 70° C. until the NCO content was 3.4%. 900 g of this solution were dispersed with vigorous stirring in 977 g of water, which was introduced at a temperature of 30° C. Stirring was continued for 5 minutes after dispersion, before, over the course of 5 minutes, a solution of 8.0 g of diethylenetriamine and 11.2 g of ethylenediamine in 100 g of water was added. After a further 10 minutes the acetone was removed by distillation under vacuum. After the dispersion had been cooled to 30° C. it was filtered through a 240 μm rapid filter.

Characteristics of the polyurethane dispersion:

| Average particle size (LCS): | 51 nm |
|---|---|
| pH (20° C.): | 8.3 |
| Solids content: | 35% |

TABLE 2
Storage stability

| | Dispersions 1, 2 and 3 | Comparative | Comparative |
|---|---|---|---|
| | inventive | dispersion 4 | dispersion 5 |
| 6 weeks 40° C. | No change | Sediment | Sediment |
| 16 weeks 20° C. | No change | Slight sediment | Slight |
| | | | sediment |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A hydrazine-free aqueous polyurethane dispersion (I) comprising
a) one or more polyisocyanates,
b) one or more polyols having average molar weights Mₙ of 500 to 6000 g/mol,
c) one or more polyols having average molar weights Mₙ of 62 to 500 g/mol,
d) one or more compounds containing an ionic group or a group capable of forming an ionic group,
e) one or more polyamines having average molecular weights Mₙ below 500 g/mol,
f) optionally one or more monoalcohols having average molar weights Mₙ of 32 to 145 g/mol and
g) optionally one or more monoamines having average molar weights Mₙ of less than 147 g/mol,
wherein at least one of f) and g) is used, the fraction of f) and/or g) being at least 0.4% to 1.26% by weight and the fraction of component c) being greater than 5.5% to 22% by weight, and the hard-segment fraction of the polyurethane dispersion being between 55% to 85% by weight, measured on the resin of the polyurethane dispersion (I).

2. An aqueous polyurethane dispersion (I) according to claim 1, wherein the dispersion contains component b) in amounts of 15% to 45% by weight.

3. An aqueous polyurethane dispersion (I) according to claim 1, wherein polyols b) include fatty acid-containing polyesters b1).

4. An aqueous polyurethane dispersion (I) according to claim 3, wherein the fatty acid-containing polyesters b1) have fatty acid-containing components which are on average bifunctional with respect to the OH groups and contain glycerol or trimethylolpropane units.

5. A process for preparing the hydrazine-free aqueous polyurethane dispersion according to claim 1, comprising
I.1) preparing an NCO prepolymer solution in a concentration of 66% to 98% in a solvent having a boiling point below 100° C. under atmospheric pressure by reacting components a), b), c) and d),
I.2) dispersing the NCO prepolymer I.1) in water, with at least partial neutralization of the ionic groups taking place before, during or after dispersion,
I.3) chain extending the NCO prepolymer with component e), and
I.4) distilling the resulting dispersion to remove the solvent,
with the proviso that component f) is used in step I.1) or component g) in step I.3).

6. A process according to claim 5, wherein component f) is used in step I.1) and component g) in step I.3).

7. A process according to claim 5, wherein component f) is used in step I.1).

8. Coating compositions comprising the hydrazine-free aqueous polyurethane dispersions according to claim 1.

9. One-component (1K) systems comprising hydrazine-free aqueous polyurethane dispersions according to claim 1 as binders.

10. Two-component (2K) systems comprising hydrazine-free aqueous polyurethane dispersions according to claim 1 as a binder.

11. Aqueous coating compositions for producing coatings on wood, plastics or open-pored mineral substrates comprising the hydrazine-free aqueous polyurethane dispersion of claim 1.

12. Substrates with one or more coatings, wherein at least one coating has been produced by applying a coating composition according to claim 8.
